(19) United States
(12) Patent Application Publication
(10) Pub. No.: US 2015/0122322 A1
(43) Pub. Date: May 7, 2015

(54) WET-TYPE SOLAR CELL AND WET-TYPE SOLAR CELL MODULE

(71) Applicant: Sharp Kabushiki Kaisha, Osaka (JP)

(72) Inventors: Atsushi Fukui, Osaka (JP); Ryoichi Komiya, Osaka (JP); Ryohsuke Yamanaka, Osaka (JP)

(21) Appl. No.: 14/359,104

(22) PCT Filed: Nov. 12, 2012
(86) PCT No.: PCT/JP2012/079214

§ 371 Date: May 18, 2014

(30) Foreign Application Priority Data
Nov. 21, 2011 (JP) 2011-253937

(51) Int. Cl. H01G 9/20

(52) U.S. Cl. CPC H01G 9/2077; H01G 9/2022
USPC 136/256; 136/244

(57) ABSTRACT

A wet-type solar cell includes a support composed of a light transmissive material and a photoelectric conversion element having a conductive layer, a photoelectric conversion layer including a porous semiconductor layer, a porous insulating layer, and a counter electrode conductive layer successively provided on the support. A first region where the photoelectric conversion layer is provided on the conductive layer and a second region where the photoelectric conversion layer is not provided on the conductive layer are present, with a scribe line portion formed by not providing the conductive layer on the support lying therebetween. The counter electrode conductive layer extends from the first region to the second region over the scribe line portion, and the scribe line portion has a line width not smaller than 70 μm.

### TECHNICAL FIELD

The present invention relates to a wet-type solar cell and a wet-type solar cell module.

### BACKGROUND ART

A solar cell for converting solar energy to electric power energy has attracted attention as a source of energy replacing fossil fuel. Solar cells including a crystalline silicon substrate and thin-film silicon solar cells have currently been put into practical use. The former, however, is disadvantageous in high cost for manufacturing a silicon substrate, and the latter is disadvantageous in high manufacturing cost because of necessity for use of various semiconductor manufacturing gases and a complicated apparatus. Therefore, though efforts for reducing cost per generated power output have been continued by enhancing efficiency in photoelectric conversion in any solar cells, the problems above have not yet been solved.

PTD 1 (Japanese Patent Laying-Open No. 01-220380) has proposed as a solar cell of a new type, a wet-type solar cell to which photoinduced electron migration of a metal complex has been applied. In this wet-type solar cell, a photoelectric conversion layer composed of an electrolytic material and a photoelectric conversion material having an absorption spectrum in a visible light region by adsorbing a photosensitizing dye is sandwiched between two electrodes and each of the electrodes is formed by forming a transparent conductive film on a surface of the glass substrate.

As the wet-type solar cell above is irradiated with light, electrons are generated in the photoelectric conversion layer and generated electrons migrate to the electrode through an external electric circuit. Migrated electrons are carried to the opposing electrode by ions in the electrolyte, and they return to the photoelectric conversion layer. Electric energy is taken out through such a series of flows of electrons.

As described above, the wet-type solar cell described in PTD 1 has such a basic structure that an electrolytic solution is introduced in between opposing glass substrates with transparent conductive film. Therefore, even though it is possible to prototype a wet-type solar cell having a small area, it is difficult to apply the wet-type solar cell described in PTD 1 to a solar cell having an area as large as 1-m square. Namely, as an area of a single solar cell is increased, a generated current increases because it is in proportion to the area. Voltage lowering, however, in a direction of a plane of the transparent conductive film used for an electrode portion increases, which leads to increase in internal series resistance as the solar cell. Consequently, such a problem as lowering in FF (fill factor) in current-voltage characteristics at the time of photoelectric conversion as well as lowering in short-circuiting current and resultant lowering in efficiency in photoelectric conversion occurs.

PTD 2 (WO1997/016838) and PTD 3 (Japanese Patent. Laying-Open No. 2002-367686) have proposed a solar cell module in which a plurality of dye sensitized solar cells are connected in series on a glass substrate with single transparent conductive film. In this dye sensitized solar cell module, individual solar cells are arranged on a transparent substrate (a glass substrate) where a transparent conductive film (an electrode) is patterned in strips, and in the individual solar cell, a porous semiconductor layer (a porous titanium oxide layer) serving as the photoelectric conversion layer, a porous insulating layer (an intermediate porous insulating layer), and a counter electrode (a catalyst layer) are successively stacked. In such a dye sensitized solar cell module, a transparent conductive film of one solar cell of adjacent solar cells and a counter electrode of the other solar cell are in contact with each other so that one solar cell and the other solar cell are connected in series to each other.

### CITATION LIST

### Patent Document

### PTD 1: Japanese Patent Laying-Open No. 01-220380

### PTD 2: WO1997/016838

### PTD 3: Japanese Patent Laying-Open No. 2002-367686

### SUMMARY OF INVENTION

### Technical Problem

A dye-sensitized solar cell (a wet-type solar cell) suffers a problem of lowering in durability due to such an external environmental factor as light, heat, or humidity. Thus, lowering in photoelectric conversion efficiency estimated to be caused by increase in counter current is observed. In particular, in a monolithic wet-type solar cell (a wet-type solar cell module), when thermal stress is applied, deterioration in performance which seems to be caused by increase in counter current is noticeable.

The present invention was made in view of the problems above, and an object thereof is to provide a wet-type solar cell achieving suppressed increase in counter current and hence improved photoelectric conversion efficiency.

### Solution to Problem

A wet-type solar cell according to the present invention includes a support composed of a light transmissive material and a photoelectric conversion element. The photoelectric conversion element has a conductive layer, a photoelectric conversion layer including a porous semiconductor layer, a porous insulating layer, and a counter electrode conductive layer successively provided on the support. In such a wet-type solar cell, a first region where the photoelectric conversion layer is provided on the conductive layer and a second region where the photoelectric conversion layer is not provided on the conductive layer are present, with a scribe line portion formed by not providing the conductive layer on the support lying therebetween. The counter electrode conductive layer extends from the first region to the second region over the scribe line portion, and the scribe line portion has a line width not smaller than 70 μm.

Preferably, the scribe line portion has a line width not greater than 500 μm.

Preferably, at least a part of the scribe line portion is in contact with an electrolytic solution present in a cavity in the porous insulating layer.

Preferably, the porous insulating layer is provided on the scribe line portion.

Preferably, the porous insulating layer has a pore diameter not smaller than 50 μm.

Preferably, the porous insulating layer contains at least one of zirconium oxide and titanium oxide having an average particle size not smaller than 100 nm.

Preferably, the porous semiconductor layer contains titanium oxide having an average particle size not greater than 100 nm.

A wet-type solar cell module according to the present invention is constructed such that two or more wet-type solar cells are connected in series. At least one wet-type solar cell includes the photoelectric conversion element included in the wet-type solar cell according to the present invention, and the photoelectric conversion element included in the wet-type solar cell is provided on one support. A conductive layer of one wet-type solar cell of adjacent wet-type solar cells is electrically connected to a counter electrode conductive layer of the other wet-type solar cell. Between one wet-type solar cell and the other wet-type solar cell, an insulating member preventing an electrolytic solution contained in one wet-type solar cell from moving to the other wet-type solar cell is provided.

Preferably, the insulating member is not in direct contact with the scribe line portion. The “insulating member being not in direct contact with the scribe line portion” here means that there is no contact point between the insulating member and the scribe line portion. Therefore, the “insulating member being not in direct contact with the scribe line portion” includes connection of the insulating member to a scribe line with a member other than the scribe line portion being interposed.

### Advantageous Effects of Invention

Since a wet-type solar cell according to the present invention can prevent lowering in durability due to such an external environmental factor as heat, photoelectric conversion efficiency is improved.

### BRIEF DESCRIPTION OF DRAWINGS

FIG. 1 is a schematic cross-sectional view of a wet-type solar cell according to one embodiment of the present invention.

FIG. 2 is a schematic cross-sectional view of a wet-type solar cell module according to one embodiment of the present invention.

FIG. 3 is a graph showing a result of change over time in rate (%) of retention of conversion efficiency with respect to a sandwich cell.

### DESCRIPTION OF EMBODIMENTS

A wet-type solar cell and a wet-type solar cell module according to the present invention will be described below with reference to the drawings. It is noted that the same reference numerals in the drawings of the present invention refer to the same or corresponding elements. Relation of such a dimension as a length, a width, a thickness, or a depth is modified as appropriate for clarity and brevity of the drawings and does not represent actual dimensional relation.

<Construction of Wet-Type Solar Cell>

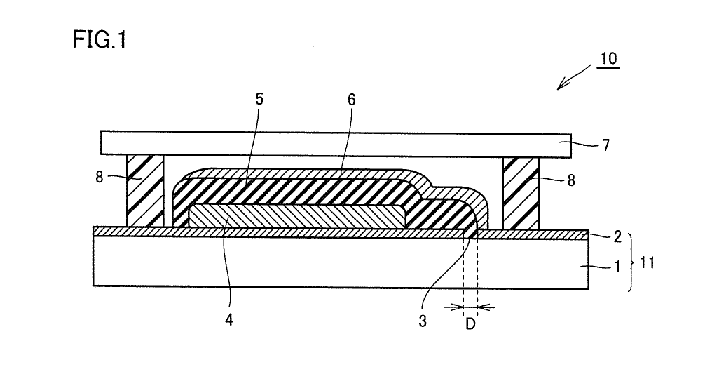

FIG. 1 is a schematic cross-sectional view of a wet-type solar cell 10 according to the present invention. In wet-type solar cell 10 according to the present invention, a conductive layer 2, a photoelectric conversion layer 4, a porous insulating layer 5, a counter electrode conductive layer 6, and a carrier transfer layer are successively provided on a support 1, and in the present invention, conductive layer 2, photoelectric conversion layer 4, porous insulating layer 5, counter electrode conductive layer 6, and the carrier transfer layer form a photoelectric conversion element. The carrier transfer layer is preferably sealed with a cover layer 7 and an insulating member 8.

In wet-type solar cell 10 according to the present invention, a first region where photoelectric conversion layer 4 is provided on conductive layer 2 and a second region where photoelectric conversion layer 4 is not provided on conductive layer 2 are present, and the first region and the second region are present with a scribe line portion 3 lying therebetween. Scribe line portion 3 is formed by not providing conductive layer 2 on support 1.

Counter electrode conductive layer 6 extends from the first region to the second region over scribe line portion 3. Therefore, counter electrode conductive layer 6 provided on porous insulating layer 5 can electrically be connected to (for example, brought in contact with) conductive layer 2 in the second region. Thus, by successively forming photoelectric conversion layer 4, porous insulating layer 5, counter electrode conductive layer 6, and the carrier transfer layer on conductive layer 2 in the second region, a wet-type solar cell module 20 which will be described later can be manufactured.

In order to form counter electrode conductive layer 6 as above, porous insulating layer 5 is preferably provided on scribe line portion 3 without photoelectric conversion layer 4 being interposed. If a porous insulating layer is formed on a scribe line portion with a photoelectric conversion layer being interposed, short-circuiting between conductive layer 2 and counter electrode conductive layer 6 is likely owing to the photoelectric conversion layer, and output of the wet-type solar cell may be lowered. If a porous insulating layer is not provided on the scribe line portion, short-circuiting due to contact between the counter electrode conductive layer and the conductive layer in the first region is likely, which may cause lowering in performance of the wet-type solar cell.

In wet-type solar cell 10 according to the present invention, scribe line portion 3 has a line width D not smaller than 70 μm. Normally, the scribe line portion is preferably formed by carrying out working once, from a point of view of production tact. In other solar cells having a glass plate with transparent conductive layer (such as a silicon thin-film solar cell or a CIGS solar cell) as well, a scribe line portion is formed by carrying out working once, or several scribe line portions are formed in parallel at intervals for suppression of lowering in yield due to short-circuiting. Thus, general short-circuiting can sufficiently be suppressed. A conventional scribe line portion has a line width around 50 μm.

If a monolithic wet-type solar cell (a wet-type solar cell module according to the present invention) is manufactured by connecting in series on one substrate, two or more wet-type solar cells in which a scribe line portion has a line width around 50 μm and the obtained monolithic wet-type solar cell is subjected, for example, to a heat resistance test at 85° C. (application of thermal stress), even in a case that a plurality of scribe line portions are formed in parallel at intervals, photoelectric conversion efficiency of the monolithic wet-type solar cell significantly lowers. Though a cause is not clear, increase in counter current between regions partitioned by a scribe line portion may be the cause.

In the present invention, line width D of scribe line portion 3 is set to 70 μm or greater, so as to be able to suppress increase in counter current between regions partitioned by scribe line portion 3 and lowering in photoelectric conversion efficiency due to such an external environmental factor as heat. Features of wet-type solar cell 10 will be shown below.

<Support>

A material forming support 1 is not particularly limited so long as the material can generally be used for a support of a wet-type solar cell and can exhibit an effect of the present invention. Support 1, however, should have a light transmissive property in a portion serving as a light receiving surface of wet-type solar cell 10. Therefore, preferably, the support is composed of a material having a light transmissive property. For example, support 1 should only be made from a glass substrate of soda glass, fused silica glass, or crystal silica glass, and it may be made from a heat resistant resin plate such as a flexible film. Even though support 1 is used as a light receiving surface, it should only substantially allow passage of light of a wavelength at least effectively sensitive to a sensitizing dye which will be described later (transmissivity of light, for example, not lower than 80%, and preferably not lower than 90%), and it does not necessarily have to have a property to transmit light in all wavelengths.

Examples of a material forming the flexible film (hereinafter also referred to as a “film”) include tetraacetyl cellulose (TAC), polyethylene terephthalate (PET), polyphenylene sulfide (PPS), polycarbonate (PC), polyarylate (PA), polyetherimide (PEI), phenoxy resin, or polytetrafluoroethylene (PTFE).

In a case where other layers are formed on support 1 through heating, for example, in a case of forming a porous semiconductor layer on support 1 through heating to approximately 250° C., among the materials forming the film above, polytetrafluoroethylene having resistance to heat not lower than 250° C. is particularly preferred.

Support 1 can be made use of when completed wet-type solar cell 10 is attached to another structure. Namely, a peripheral portion of support 1 such as a glass substrate can readily be attached to another support by using a metalworked part and a screw.

Though a thickness of support 1 is not particularly limited, in consideration of a light transmissive property, the thickness is preferably approximately from 0.2 mm to 5 mm.

<Conductive Layer>

A material forming conductive layer 2 is not particularly limited so long as the material can generally be used for a conductive layer of a wet-type solar cell and can exhibit an effect of the present invention. Conductive layer 2, however, serves as a light receiving surface of wet-type solar cell 10, and therefore, it should have a light transmissive property and it is preferably composed of a light transmissive material. For example, conductive layer 2 is preferably composed of indium-tin composite oxide (ITO), fluorine-doped tin oxide (FTO), or zinc oxide (ZnO). Likewise support 1, conductive layer 2 should only substantially allow passage of light of a wavelength at least effectively sensitive to a sensitizing dye which will be described later (transmissivity of light, for example, not lower than 80%, and preferably not lower than 90%), and it does not necessarily have to have a property to transmit light in all wavelengths

Though a film thickness of conductive layer 2 is not particularly limited, it is preferably approximately from 0.02 to 5 μm. A film resistance of conductive layer 2 is preferably as low as possible, preferably not higher than 40 Ω/sq.

For achieving lower resistance, conductive layer 2 may be provided with a metal lead. Examples of a material for the metal lead include platinum, gold, silver, copper, aluminum, nickel, or titanium. Though a thickness of the metal lead is not particularly limited, too large a thickness of the metal lead may result in lowering in amount of incident light on a light receiving surface, and hence the metal lead preferably has a thickness approximately from 0.1 to 4 mm.

A structure in which conductive layer 2 is stacked on support 1 may be denoted as a transparent electrode substrate 11 in the present invention. An example of such a transparent electrode substrate 11 is a transparent electrode substrate in which conductive layer 2 composed of FTO is stacked on support 1 composed of soda lime float glass, which is suitably employed in the present invention.

<Scribe Line Portion>

Scribe line portion 3 has line width D not smaller than 70 μm, preferably not smaller than 100 μm, and more preferably not smaller than 200 μm. As scribe line portion 3 has greater line width D, increase in counter current due to heat between regions partitioned by scribe line portion 3 can be suppressed and hence lowering in photoelectric conversion efficiency due to such an external environmental factor as heat can be suppressed. Scribe line portion 3, however, preferably has line width D not greater than 500 μm. When scribe line portion 3 has line width D exceeding 500 μm, a size of photoelectric conversion layer 4 (lowering in light receiving area ratio) decreases, which may lower photoelectric conversion efficiency.

A part of scribe line portion 3 (preferably, scribe line portion 3 as a whole) is preferably in contact with an electrolytic solution present in a cavity in porous insulating layer 5. In this case, an effect of the present invention is noticeable Here, the electrolytic solution represents one example of a carrier transfer material which will be described later, and composition thereof is as shown below.

A method of forming scribe line portion 3 is not particularly limited. For example, conductive layer 2 may be formed on the entire upper surface of support 1, and then a portion of conductive layer 2 to become scribe line portion 3 may be removed by laser scribing. Alternatively, a mask may be provided on a portion of the upper surface of support 1 to become scribe line portion 3, then conductive layer 2 may be formed on a portion of the upper surface of support 1 where no mask is provided, and thereafter the mask may be removed.

<Photoelectric Conversion Layer>

Photoelectric conversion layer 4 is obtained by adsorbing a sensitizing dye or a quantum dot to a porous semiconductor layer and filling the layer with a carrier transfer material.

Porous Semiconductor Layer

A form of a porous semiconductor layer is exemplified by a layer containing a bulk or particulate semiconductor material and a film form having numerous small pores formed, however, a film form having numerous small pores formed is preferred. Thus, an amount of adsorption of a sensitizing dye and an amount of filling with a carrier transfer material can sufficiently be ensured.

Porosity of the porous semiconductor layer refers to void ratio not lower than 20% and a specific surface area from 0.5 to 300 m²/g. From a point of view of a sufficiently ensured amount of adsorption of a sensitizing dye, a specific surface area of the porous semiconductor layer is preferably approximately from 10 to 200 m²/g. Here, void ratio of a porous semiconductor layer is found by calculation from a thickness (film thickness) of the porous semiconductor layer, a mass of the porous semiconductor layer, and density of semiconductor fine particles. A specific surface area of a porous semiconductor layer is found with the BET method which represents a gas adsorption method.

A semiconductor material forming a porous semiconductor layer is not particularly limited so long as the material is generally used as a material for photoelectric conversion. Examples of such a material include a compound such as titanium oxide, zinc oxide, tin oxide, iron oxide, niobium oxide, cerium oxide, tungsten oxide, nickel oxide, strontium titanate, cadmium sulfide, lead sulfide, zinc sulfide, indium phosphide, copper-indium sulfide (CuInS₂), CuAlO₂, or SrCu₂O₂. Such a compound alone may be employed, or these compounds may be employed as combined. Among these compounds, titanium oxide, zinc oxide, tin oxide, or niobium oxide is preferably employed. Titanium oxide is preferably employed from a point of view of photoelectric conversion efficiency, stability, and safety.

In the present invention, in a case that titanium oxide is employed as a material for forming the porous semiconductor layer, titanium oxide may be various narrowly-defined titanium oxides such as anatase-type titanium oxide, rutile-type titanium oxide, amorphous titanium oxide, metatitanic acid, or orthotitanic acid, titanium hydroxide, or hydrous titanium oxide. Titanium oxide may be used alone or titanium oxides may be used as mixed. Anatase-type titanium oxide and rutile-type titanium oxide can be in any form depending on a manufacturing method thereof or thermal hysteresis, however, the anatase-type titanium oxide is general.

An average particle size of a semiconductor material is not particularly limited, and it should only be set as appropriate in consideration of the fact that a light scattering property of photoelectric conversion layer 4 can be adjusted based on an average particle size of the semiconductor material. Although depending on a condition for forming photoelectric conversion layer 4, specifically in a case that photoelectric conversion layer 4 includes a porous semiconductor layer formed of a semiconductor material great in average particle size, photoelectric conversion layer 4 has a high light scattering property and incident light is scattered, which contributes to improvement in light capturing rate. Alternatively, in a case that photoelectric conversion layer 4 includes a porous semiconductor layer formed of a semiconductor material small in average particle size, photoelectric conversion layer 4 does not have an excellent light scattering property but has the increased number of photosensitizing dye adsorption points, which contributes to increase in amount of adsorption. Though a porous semiconductor layer may be formed from a single layer formed of a semiconductor material substantially the same in average particle size, it may be formed by stacking a layer formed of a semiconductor material relatively small in average particle size and a layer formed of a semiconductor material relatively large in average particle size. A semiconductor material relatively small in average particle size should only have an average particle size not smaller than 5 nm and smaller than 50 nm and it has an average particle size preferably not smaller than 10 nm and not greater than 30 nm. Since an effective surface area sufficiently greater than a projection area is thus obtained, such an effect that incident light can be converted to electric energy at high yield is also obtained. A semiconductor material relatively great in average particle size should only have an average particle size not smaller than 50 nm, and it has an average particle size preferably not smaller than 50 nm and not greater than 600 nm and more preferably not smaller than 50 nm and not greater than 100 nm. An average particle size of a semiconductor material uniform to some extent is preferred as in the case of commercially available semiconductor materials, from a point of view of effective use of incident light for photoelectric conversion.

From the foregoing, from a point of view of improvement in photoelectric conversion efficiency, stability, safety, and a light scattering property, titanium oxide having an average particle size preferably not smaller than 50 nm and more preferably not smaller than 50 nm and not greater than 100 nm is employed as a semiconductor material. Though details are not clear, suppression of lowering in photoelectric conversion efficiency due to such an external factor as heat in the present invention is particularly more noticeable in a case of use of titanium oxide as a semiconductor material than in a case of use of an oxide different from titanium oxide as a semiconductor material.

Herein, an average particle size refers to a value determined based on a diffraction peak in XRD (X-ray diffraction). Specifically, an average particle size is calculated from a half width of a diffraction angle in θ/2θ measurement in XRD and from Scherre's Equation. For example, in a case that anatase-type titanium oxide is employed as a semiconductor material, a half width of a diffraction peak corresponding to a (101) plane (2θ=around 25.3°) should only be measured.

Though a film thickness of photoelectric conversion layer (porous semiconductor layer) 4 is not particularly limited, from a point of view of photoelectric conversion efficiency, the film thickness is preferably approximately from 0.5 to 50 μm. In particular, in a case that photoelectric conversion layer 4 includes a porous semiconductor layer formed of a semiconductor material having an average particle size not smaller than 50 nm, it has a film thickness preferably from 0.1 to 40 μm and more preferably from 5 to 20 μm. In a case that photoelectric conversion layer 4 includes a porous semiconductor layer formed of a semiconductor material having an average particle size not smaller than 5 nm and smaller than 50 nm, it has a film thickness preferably from 0.1 to 50 μm and more preferably from 10 to 40 μm.

An insulating layer is generally provided between a photoelectric conversion layer formed from a porous semiconductor layer and a counter electrode conductive layer. As disclosed, for example, in Japanese Patent Laying-Open No. 2007-194039, however, a counter electrode conductive layer or a conductive layer (a single layer) may be formed on a photoelectric conversion layer including a porous semiconductor layer formed of a semiconductor material having a large average particle size (an average particle size approximately from 100 nm to 500 nm). When a semiconductor material forming a portion of the photoelectric conversion layer in contact with the counter electrode conductive layer has a large average particle size, however, the photoelectric conversion layer is low in mechanical strength and hence a problem as a structure of a wet-type solar cell may arise. In such a case, the photoelectric conversion layer may mechanically be strengthened by blending a semiconductor material small in average particle size in a semiconductor material large in average particle size, for example, at a ratio of 10 mass % or lower with respect to the materials in total.

Sensitizing Dye

Examples of a dye functioning as a photosensitizer, to be adsorbed to a porous semiconductor layer, include organic dyes having absorbability in at least one of a visible light region and an infrared region, or metal complex dyes. One of these dyes may be employed alone, or two or more types may be employed as mixed.

Examples of an organic dye include an azo-based dye, a quinone-based dye, a quinone-imine-based dye, a quinacridone-based dye, a squarylium-based dye, a cyanine-based dye, a merocyanine-based dye, a triphenylmethane-based dye, a xanthene-based dye, a porphyrin-based dye, a perylene-based dye, an indigo-based dye, a phthalocyanine-based dye, or a naphthalocyanine-based dye. An organic dye is generally higher in extinction coefficient than a metal complex dye.

Examples of a metal complex dye include a dye in which a molecule (a ligand) is coordinated to a transition metal. A transition metal is exemplified by Cu, Ni, Fe, Co, V, Sn, Si, Ti, Ge, Cr, Zn, Ru, Mg, Al, Pb, Mn, In, Mo, Y, Zr, Nb, Sb, La, W, Pt, Ta, Ir, Pd, Os, Ga, Tb, Eu, Rb, Bi, Se, As, Sc, Ag, Cd, Hf, Re, Au, Ac, Tc, Te, or Rh. A phthalocyanine-based metal complex dye or a ruthenium-based dye is exemplified as a metal complex dye. A ruthenium-based metal complex dye is preferred and ruthenium-based metal complex dyes expressed in the following chemical formulae (1) to (3) are further preferred.

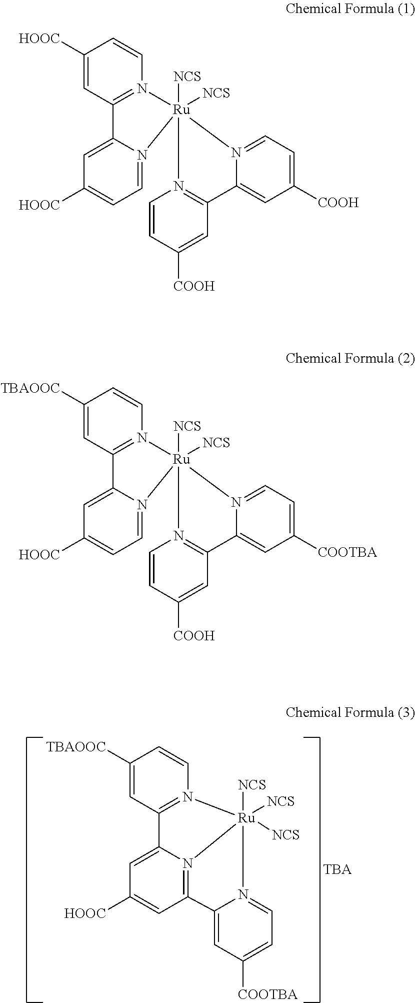

In order to securely adsorb a sensitizing dye to a porous semiconductor layer, a sensitizing dye preferably has, in a molecule, an interlocking group such as a carboxylic acid group, a carboxylic acid anhydride group, an alkoxy group, a hydroxyl group, a hydroxyalkyl group, a sulfonic acid group, an ester group, a mercapto group, or a phosphonyl group, and more preferably has a carboxylic acid group or a carboxylic acid anhydride group. Here, an interlocking group provides electrical coupling facilitating electron migration between an excited state of a sensitizing dye and a conduction band of a semiconductor material.

Examples of a quantum dot adsorbing to a porous semiconductor layer and functioning as a photosensitizer include CdS, CdSe, PbS, or PbSe.

An amount of adsorption of such a sensitizing dye should only be not lower than 1×10⁻⁸ mol/cm² and not higher than 1×10⁻⁶ mol/cm² and it is preferably not lower than 5×10⁻⁸ mol/cm² and not higher than 5×10⁻⁸ mol/cm². When an amount of adsorption of a sensitizing dye is lower than 1×10⁻⁷ mol/cm², photoelectric conversion efficiency may be lowered. When an amount of adsorption of a sensitizing dye exceeds 1×10⁻⁶ mol/cm², an open circuit voltage may disadvantageously be low.

A method of adsorbing a sensitizing dye to the porous semiconductor layer is representatively exemplified by a method of immersing the porous semiconductor layer in a solution in which a sensitizing dye has been dissolved (a solution for dye adsorption). Here, in order to permeate the solution for dye adsorption into a deep portion of small pores in the porous semiconductor layer, the solution for dye adsorption is preferably heated.

A carrier transfer material with which a porous semiconductor layer is filled is as described in <Carrier Transfer Layer> which will be described later.

<Porous Insulating Layer>

In a wet-type solar cell, porous insulating layer 5 is generally provided between photoelectric conversion layer 4 and counter electrode conductive layer 6. Here, porosity of porous insulating layer 5 refers to void ratio not lower than 10% and a specific surface area from 0.5 to 300 m²/g. A diameter of pores in such porous insulating layer 5 should only be not smaller than 20 μm and is preferably not smaller than 50 μm and not greater than 500 μm. In other words, porous insulating layer 5 should only be made of particles having an average particle size from 5 to 500 nm and is preferably made of particles having an average particle size from 10 to 300 nm. Thus, porous insulating layer 5 can retain a carrier transfer material and migration of carriers in a cavity in porous insulating layer 5 is facilitated. A diameter of pores in porous insulating layer 5 is measured, for example, with the BET method. The method described in <Photoelectric Conversion Layer> above can be employed as a method of measurement of each of void ratio of porous insulating layer 5 and an average particle size of particles forming porous insulating layer 5.

A material for porous insulating layer 5 is not particularly limited, and it may be glass or an insulating material high in level of a conduction band, such as zirconium oxide, silicon oxide, aluminum oxide, niobium oxide, or strontium titanate. Preferably, porous insulating layer 5 contains at least one of zirconium oxide and titanium oxide having an average particle size not smaller than 100 nm. Short-circuiting between a positive electrode and a negative electrode can thus be prevented and performance of a wet-type solar cell is improved.

Though a film thickness of porous insulating layer 5 is not particularly limited, from a point of view of electrical insulation between a positive electrode and a negative electrode, it should only be not smaller than 0.5 μm and not greater than 30 μm and is preferably not smaller than 1 μm and not greater than 15 μm.

<Counter Electrode Conductive Layer>

Combination of a catalyst layer having catalytic capability and a function to reduce holes in a carrier transfer layer and a conductive layer having a function to collect electrons and establish connection in series with an adjacent wet-type solar cell is referred to as counter electrode conductive layer 6 in the present invention. Therefore, counter electrode conductive layer 6 may be formed by stacking a catalyst layer and a conductive layer, or may be formed from a catalyst layer (a single layer) having high conductivity or a conductive layer (a single layer) having catalytic capability. The present invention also includes an embodiment in which a catalyst layer is further provided separately from counter electrode conductive layer 6.

In a case that counter electrode conductive layer 6 has a stack structure of a catalyst layer and a conductive layer, normally, a catalyst layer is formed on porous insulating layer 5 and a conductive layer is formed on the catalyst layer. In a case where film strength of a formed catalyst layer is not so high as in the case of a catalyst layer (such as a platinum layer) formed with a vapor deposition method, when the conductive layer is formed on the catalyst layer formed on the porous insulating layer, the conductive layer may peel off from the catalyst layer. In this case, the conductive layer should only be provided on porous insulating layer 5 and the catalyst layer should only be provided on that conductive layer.

A material for forming a conductive layer of counter electrode conductive layer 6 is not particularly limited so long as the material can generally be used for a conductive layer of a wet-type solar cell and can exhibit an effect of the present invention. A material for the conductive layer may be, for example, a metal oxide such as indium-tin composite oxide (ITO), fluorine-doped tin oxide (FTO), or zinc oxide (ZnO), or a metal material such as titanium, tungsten, gold, silver, copper, or nickel. Taking into account film strength of the conductive layer, titanium is most preferred as a material for forming the conductive layer.

In forming the conductive layer of counter electrode conductive layer 6 with a vapor deposition method, the conductive layer itself becomes porous and therefore it is not necessary to separately form in the conductive layer, pores through which a dye solution or a carrier transfer material migrates. In a case of forming the conductive layer of counter electrode conductive layer 6 with a vapor deposition method, a pore automatically formed in the conductive layer has a pore diameter approximately from 1 nm to 20 nm. It has been confirmed that, even though a catalyst layer is formed on this conductive layer, there is no possibility that a material forming the catalyst layer passes through pores formed in the conductive layer to reach porous insulating layer 5 and further to a porous semiconductor layer (photoelectric conversion layer 4).

In a case where a catalyst layer of counter electrode conductive layer 6 is formed with an application method with the use of a paste in which fine particles of platinum or carbon have been dispersed, fine particles forming the catalyst layer may pass through the conductive layer of counter electrode conductive layer 6. In this case, the conductive layer of counter electrode conductive layer 6 is preferably a dense layer, and pores should only be formed simultaneously in the conductive layer of counter electrode conductive layer 6 and in the catalyst layer of counter electrode conductive layer 6 after the catalyst layer of counter electrode conductive layer 6 is formed. In such a case, a material for the conductive layer of counter electrode conductive layer 6 should only be, for example, a metal oxide including indium-tin composite oxide (ITO), fluorine-doped tin oxide (FTO), or zinc oxide (ZnO), or a metal material including titanium, tungsten, gold, silver, copper, or nickel.

In a case that pores are intentionally formed in counter electrode conductive layer 6, for example, counter electrode conductive layer 6 is preferably partially evaporated through irradiation with laser beams. Such a pore should only have a diameter from 0.1 μm to 100 μm and has a diameter preferably from 1 μm to 100 μm. An interval between pores should only be from 1 μm to 200 μm and preferably from 5 μm to 200 μm

A film thickness of counter electrode conductive layer 6 is not particularly limited. Too small a film thickness of counter electrode conductive layer 6, however, leads to high resistance of counter electrode conductive layer 6, and too large a film thickness of counter electrode conductive layer 6 leads to interference with migration of a carrier transfer material. A film thickness of counter electrode conductive layer 6 should only be selected as appropriate in consideration of this fact, and a film thickness of counter electrode conductive layer 6 should only be approximately from 0.05 to 100 μm.

A material forming a catalyst layer of counter electrode conductive layer 6 is not particularly limited so long as the material can generally be used for a catalyst layer of a wet-type solar cell and can exhibit an effect of the present invention. For example, platinum or carbon is preferred as such a material. Preferred forms of carbon include carbon black, graphite, glass carbon, amorphous carbon, hard carbon, soft carbon, carbon whisker, carbon nanotube, or fullerene.

Counter electrode conductive layer 6 is provided with an extraction electrode (not shown) as necessary. By using the extraction electrode, a current can be extracted from the wet-type solar cell to the outside. A material for an extraction electrode is not particularly limited so long as the material can generally be used for a wet-type solar cell and can exhibit an effect of the present invention.

<Cover Layer>

Cover layer 7 is provided in order to prevent volatilization of an electrolytic solution and introduction of water or the like into the cell. A material forming cover layer 7 is not particularly limited so long as the material can generally be used for a cover layer of a wet-type solar cell and can exhibit an effect of the present invention. Examples of such a material include soda lime glass, lead glass, borosilicate glass, fused silica glass, or crystalline silica glass, and soda lime float glass is preferred.

<Insulating Member>

Insulating member 8 is provided in order to prevent volatilization of an electrolytic solution and introduction of water or the like into the cell as well as to fulfill such purposes as absorption of impact (stress) of a drop applied to support 1 and absorption of bending or the like applied to support 1 during long-time use. In addition, insulating member 8 prevents movement of a carrier transfer agent (such as an electrolytic solution) between adjacent wet-type solar cells 10 during manufacturing of wet-type solar cell module 20, which will be described later, with wet-type solar cell 10 according to the present invention.

A material forming insulating member 8 is not particularly limited so long as the material can generally be used for an insulating member of a wet-type solar cell and can exhibit an effect of the present invention. Such a material may be, for example, a silicone resin, an epoxy resin, or a polyisobutylene-based resin, such a hot melt resin as a polyamide-based resin, a polyolefin-based resin, or an ionomer resin, or glass frit. In forming insulating member 8 by using two or more types of these materials, two or more types of these materials may be mixed, or a layer composed of each material may be stacked. In a case where a nitrile-based solvent or a carbonate-based solvent is employed as a solvent for an oxidation-reduction electrolyte, a silicone resin, a hot melt resin, a polyisobutylene-based resin, or glass frit is preferred as a material forming insulating member 8.

<Carrier Transfer Layer>

The “carrier transfer layer” in the present invention is formed by introduction of a carrier transfer material into a region located on an inner side of insulating member 8 and sandwiched between conductive layer 2 and cover layer 7. Therefore, at least photoelectric conversion layer 4 and porous insulating layer 5 are filled with a carrier transfer material.

The carrier transfer material should only be formed of a conductive material capable of transferring ions, and should only be, for example, a liquid electrolyte, a solid electrolyte, a gel electrolyte, or a fused salt gel electrolyte.

A liquid electrolyte should only be a liquid substance containing a redox species, and it is not particularly limited so long as it can generally be used in a battery, a solar cell, or the like. Specifically, a liquid electrolyte should only be a liquid electrolyte formed of a redox specifies and a solvent capable of dissolving the same, a liquid electrolyte formed of a redox species and fused salt capable of dissolving the same, or a liquid electrolyte formed of a redox species, the solvent above, and the fused salt above.

Examples of redox species include an I⁻/I³⁻ type, a Br²⁻/Br³⁻ type, an Fe²⁺/Fe³⁺type, or a quinone/hydroquinone type. Specifically, a redox species may be combination of iodine (I₂) and a metal iodide such as lithium iodide (LiI), sodium iodide (NaI), potassium iodide (KI), or calcium iodide (CaI₂). A redox species may be combination of iodine and tetraalkyl ammonium salt such as tetraethyl ammonium iodide (TEAI), tetrapropyl ammonium iodide (TPAI), tetrabutyl ammonium iodide (TBAI), or tetrahexyl ammonium iodide (THAI). A redox species may be combination of bromine and a metal bromide such as lithium bromide (LiBr), sodium bromide (NaBr), potassium bromide (KBr), or calcium bromide (CaBr₂). Among these, combination of LiI and I₂ is particularly preferred.

Examples of a solvent capable of dissolving a redox species include a carbonate compound such as propylene carbonate, a nitrile compound such as acetonitrile, alcohols such as ethanol, water, or an aprotic polar substance. Among these, a carbonate compound or a nitrile compound is particularly preferred. These solvents can also be employed as a mixture of two or more types.

A solid electrolyte is a conductive material capable of transferring electrons, holes, or ions, and should only be a material which can be employed as an electrolyte for a wet-type solar cell and has no fluidity. Specifically, a hole transfer material such as polycarbazole, an electron transfer material such as tetranitro fluorenone, a conductive polymer such as polyrrole, a polymeric electrolyte obtained by solidifying a liquid electrolyte with a polymeric compound, a p-type semiconductor such as copper iodide or copper thiocyanate, or an electrolyte obtained by solidifying a liquid electrolyte containing fused salt with fine particles is exemplified as a solid electrolyte.

A gel electrolyte is normally composed of an electrolyte and a gelling agent. An electrolyte may be, for example, a liquid electrolyte above or a solid electrolyte above.

Examples of a gelling agent include a polymeric gelling agent such as a cross-linked polyacrylic resin derivative, a cross-linked polyacrylonitrile derivative, a polyalkylene oxide derivative, silicone resins, or a polymer having a nitrogen-containing heterocyclic quaternary compound salt structure in a side chain.

A fused salt gel electrolyte is normally composed of the gel electrolyte as above and ambient-temperature fused salt.

Examples of ambient-temperature fused salt include nitrogen-containing heterocyclic quaternary ammonium salts such as pyridinium salts or imidazolium salts.

The electrolyte above may contain as necessary an additive shown below. An additive may be a nitrogen-containing aromatic compound such as t-butyl pyridine (TBP), or imidazole salt such as dimethylpropyl imidazole iodide (DMPII), methylpropyl imidazole iodide (MPII), ethylmethyl imidazole iodide (EMII), ethyl imidazole iodide (EII), or hexylmethyl imidazole iodide (HMII).

A concentration of the electrolyte is preferably in a range from 0.001 to 1.5 mol/liter and particularly preferably in a range from 0.01 to 0.7 mol/liter. If a catalyst layer of counter electrode conductive layer 6 is located on the light receiving surface side in the wet-type solar cell according to the present invention, however, incident light passes through an electrolytic solution in the carrier transfer layer to reach a porous semiconductor layer to which a sensitizing dye has been adsorbed and thus carriers are excited. Thus, manufacturing may depend on a concentration of an electrolyte in the wet-type solar cell having a catalyst layer on the light receiving surface side. A concentration of an electrolyte is preferably set in consideration of this fact.

<Method of Manufacturing Wet-Type Solar Cell>

A method of manufacturing wet-type solar cell 10 shown in FIG. 1 will be shown below.

Conductive layer 2 is formed on support 1. Here, a method of forming conductive layer 2 is not particularly limited, and for example, a known sputtering method or a known spraying method should only be employed. In a case where conductive layer 2 is provided with a metal lead (not shown), for example, a metal lead may be formed on support 1 with a known sputtering method or a known vapor deposition method and then conductive layer 2 may be formed on support 1 including the obtained metal lead, or conductive layer 2 may be formed on support 1 and then a metal lead may be formed on conductive layer 2.

Scribe line portion 3 is then formed by cutting a part of conductive layer 2 with laser scribing. Here, working of conductive layer 2 should only be repeatedly carried out until scribe line portion 3 has line width D of a desired value (not smaller than 70 μm, preferably not smaller than 100 μm and not greater than 500 μm, and more preferably not smaller than 200 μm and not greater than 500 μm).

In succession, a porous semiconductor layer is formed on conductive layer 2. A method of forming a porous semiconductor layer is not particularly limited, and a paste containing a particulate semiconductor material may be applied onto conductive layer 2 with a screen printing method or an ink jet method followed by firing, or instead of firing, a sol-gel method or electrochemical oxidation-reduction reaction may be made use of. Among these methods, a screen printing method using a paste is particularly preferred because a thick porous semiconductor layer can be formed with low cost.

A method of forming a porous semiconductor layer with the use of titanium oxide serving as a semiconductor material will specifically be shown below.

Initially, 125 mL of titanium isopropoxide (manufactured by Kishida Chemical Co., Ltd.) is dropped into 750 mL of 0.1 M nitric acid aqueous solution (manufactured by Kishida Chemical Co., Ltd.) to cause hydrolysis. The aqueous solution is heated at 80° C. for 8 hours to prepare a sol liquid. The obtained sol liquid is heated in an autoclave made of titanium at 230° C. for 11 hours to grow titanium oxide particles. Then, the titanium oxide particles are dispersed with ultrasound for 30 minutes to prepare a colloid solution containing the titanium oxide particles having an average particle size (an average primary particle size) of 15 nm. Then, ethanol twice as much in volume as the obtained colloid solution is added thereto and the resultant substance is subjected to centrifugal separation at the number of revolutions of 5000 rpm. Thus, titanium oxide particles are obtained.

Then, the obtained titanium oxide particles are washed. Thereafter, a substance obtained by dissolving ethyl cellulose and terpineol in dehydrated ethanol is mixed with the titanium oxide particles and they are stirred, to thereby disperse the titanium oxide particles. Thereafter, the mixture solution is heated under a vacuum condition to evaporate ethanol, to thereby obtain a titanium oxide paste. Concentration is adjusted, for example, such that final composition of titanium oxide solid concentration of 20 wt %, ethyl cellulose concentration of 10 wt %, and terpineol concentration of 64 wt % is achieved.

Here, examples of a solvent used for preparing a titanium oxide paste include, other than the above, a glyme-based solvent such as ethylene glycol monomethyl ether, an alcohol-based solvent such as isopropyl alcohol, a mixture solvent such as isopropyl alcohol/toluene, or water. In preparing a paste containing semiconductor particles other than titanium oxide as well, these solvents can be employed.

Then, with the method above, the titanium oxide paste is applied onto the conductive layer and dried and fired. Thus, a porous semiconductor layer composed of titanium oxide is obtained. Here, a condition for drying and firing such as a condition for a temperature, a time period, or an atmosphere is adjusted as appropriate, depending on a material for a support or a semiconductor material to be used. Firing is preferably carried out, for example, in an atmosphere or in an inert gas atmosphere in a range approximately from 50 to 800° C. for approximately 10 seconds to 12 hours. Drying and firing may be carried out once at a single temperature or two or more times with a temperature being varied.

In succession, porous insulating layer 5 is formed on the porous semiconductor layer. A method of forming porous insulating layer 5 is not particularly limited, and a known method is exemplified. Specifically, a method of applying a paste containing an insulating material forming porous insulating layer 5 onto a porous semiconductor layer with a screen printing method or an ink jet method followed by firing may be employed, or instead of firing, a sol-gel method or a method making use of electrochemical oxidation-reduction reaction may be performed. Among these methods, a screen printing method using a paste is particularly preferred because porous insulating layer 5 can be formed with low cost

In succession, counter electrode conductive layer 6 is formed on porous insulating layer 5. A method of forming counter electrode conductive layer 6 is not particularly limited, and a vapor deposition method or a printing method should only be employed. In forming counter electrode conductive layer 6 with a vapor deposition method, counter electrode conductive layer 6 itself becomes porous, and hence it is not necessary to separately form pores in counter electrode conductive layer 6, through which a dye solution or a carrier transfer material can move. In forming pores in counter electrode conductive layer 6, a method of partial evaporation of counter electrode conductive layer 6 with irradiation with laser beams is preferably employed.

In succession, a sensitizing dye is adsorbed to the porous semiconductor layer. As a method of adsorbing a sensitizing dye, for example, a method of immersing the porous semiconductor layer in a solution in which the sensitizing dye has been dissolved (a dye adsorption solution) is exemplified. Any solvent capable of dissolving a sensitizing dye is applicable as a solvent for dissolving a sensitizing dye, and specifically, alcohols such as ethanol, ketones such as acetone, ethers such as diethyl ether and tetrahydrofuran, nitrogen compounds such as acetonitrile, halogenated aliphatic hydrocarbon such as chloroform, aliphatic hydrocarbon such as hexane, aromatic hydrocarbon such as benzene, esters such as ethyl acetate, or water are exemplified. These solvents may be employed as a mixture of two or more types.

A concentration of a sensitizing dye in a solution for dye adsorption can be adjusted as appropriate depending on a type of a sensitizing dye and a solvent to be used. For improvement in adsorption function of a sensitizing dye to a porous semiconductor layer, however, this concentration of a sensitizing dye is preferably as high as possible and should only be, for example, not lower than 5×10⁻⁴ mol/liter.

In succession, insulating member 8 is provided at a prescribed position. Specifically, initially, insulating member 8 is formed by cutting a heat seal film or an ultraviolet curable resin in a shape surrounding a stack (the stack being formed by stacking photoelectric conversion layer 4, porous insulating layer 5, and counter electrode conductive layer 6) formed on support 1. In a case of using a silicone resin, an epoxy resin, or glass frit as a material for insulating member 8, a pattern of insulating member 8 can be formed with a dispenser. In a case of using a hot melt resin as a material for insulating member 8, insulating member 8 can be formed by making a patterned hole in a sheet member composed of a hot melt resin. Insulating member 8 thus formed is arranged between transparent electrode substrate 11 and cover layer 7 so as to bond transparent electrode substrate 11 and cover layer 7 with each other. Then, insulating member 8, and transparent electrode substrate 11 and cover layer 7 are fixed through heating or irradiation with ultraviolet rays.

In succession, a carrier transfer material is introduced through an introduction hole provided in advance in cover layer 7. When a portion located on an inner side of insulating member 8 and located between conductive layer 2 and cover layer 7 is filled with a carrier transfer material, the introduction hole is sealed with an ultraviolet curable resin. With filling with the carrier transfer material, the carrier transfer layer is formed and the carrier transfer material is retained in photoelectric conversion layer 4 and porous insulating layer 5. Thus, wet-type solar cell 10 shown in FIG. 1 is manufactured.

<Wet-Type Solar Cell Module>

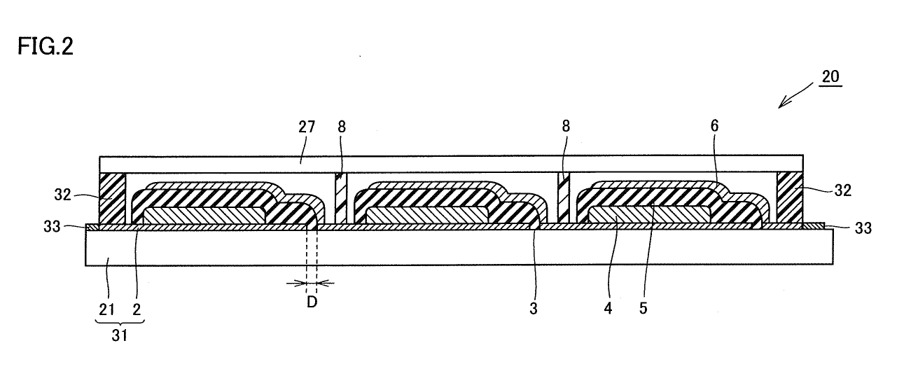

FIG. 2 is a schematic cross-sectional view of a wet-type solar cell module according to the present invention.

Wet-type solar cell module 20 according to the present invention is formed by connecting three wet-type solar cells in series, each wet-type solar cell having a photoelectric conversion element provided on one support 21. Specifically, three conductive layers 2 are provided on one support 21 with scribe line portions 3 lying therebetween, and a transparent electrode substrate 31 is thus formed. On each conductive layer 2, photoelectric conversion layer 4 resulting from adsorption of a sensitizing dye to a porous semiconductor layer, porous insulating layer 5, counter electrode conductive layer 6, and a carrier transfer layer are provided. In such a wet-type solar cell module 20, counter electrode conductive layer 6 of one wet-type solar cell of adjacent wet-type solar cells extends toward conductive layer 2 of the other wet-type solar cell over scribe line portion 3 and is electrically connected to conductive layer 2.

In wet-type solar cell module 20 according to the present invention, scribe line portion 3 in each wet-type solar cell has line width D not smaller than 70 μm, preferably not smaller than 100 μm and not greater than 500 μm, and more preferably not smaller than 200 μm and not greater than 500 μm. Since increase in counter current between regions partitioned by scribe line portion 3 can thus be suppressed, lowering in photoelectric conversion efficiency due to such an external environmental factor as heat is suppressed.

In wet-type solar cell module 20 according to the present invention, one cover layer 27 is provided above counter electrode conductive layer 6 as opposed to support 21, and insulating member 8 and a sealing member 32 are provided between support 21 and cover layer 27. Wet-type solar cells at opposing ends are sealed with support 21, cover layer 27, insulating member 8, and sealing member 32, and a central wet-type solar cell is sealed with support 21, cover layer 27, and two insulating members 8. Though a carrier transfer layer is formed by filling with a carrier transfer material, a region located on an inner side of sealing member 32 and located between support 21 and cover layer 27, the carrier transfer material can be prevented from moving between adjacent wet-type solar cells because insulating member 8 serves as a partition between adjacent wet-type solar cells. Therefore, such an effect as prevention of uneven presence of an electrolytic solution can be obtained.

Thus, insulating member 8 has a function as a partition between adjacent wet-type solar cells Therefore, as shown in FIG. 2, insulating member 8 is provided between counter electrode conductive layer 6 of one wet-type solar cell of adjacent wet-type solar cells and porous insulating layer 5 of the other wet-type solar cell. Here, since counter electrode conductive layer 6 is provided over scribe line portion 3, insulating member 8 is provided without being in direct contact with scribe line portion 3. An effect of the present invention is noticeable in such a case.

Support 21 is preferably made of a material having a light transmissive property similarly to support 1 in wet-type solar cell 10 according to the present invention, and specifically desirably made of a material which can be used as a material for support 1. Cover layer 27 is desirably made of a material which can be used as a material for cover layer 7 in wet-type solar cell 10 according to the present invention. Sealing member 32 may be made of a material substantially the same as that for insulating member 8, or a material different from that for insulating member 8 (such as a material not having insulation).

In wet-type solar cell module 20 according to the present invention, a collector electrode 33 is preferably provided on support 1 on an outer side of sealing member 32, and this collector electrode 33 is preferably connected to conductive layer 2 of a wet-type solar cell located at each of opposing ends. Thus, a current can readily be extracted from wet-type solar cell module 20 to the outside.

In wet-type solar cell module 20 shown in FIG. 2, a wet-type solar cell located in the center corresponds to wet-type solar cell 10 according to the present invention, and wet-type solar cells located at opposing ends are different in a member for sealing a carrier transfer layer from wet-type solar cell 10 according to the present invention. In wet-type solar cell module 20 according to the present invention, however, wet-type solar cells 10 according to the present invention may be connected in series. Namely, insulating member 8 may be employed instead of sealing member 32.

In wet-type solar cell module 20 according to the present invention, the number of wet-type solar cells forming wet-type solar cell module 20 is not limited to three.

### EXAMPLES

Though the present invention will be described further specifically with reference to Examples and Comparative Examples, the present invention is not limited to these Examples and Comparative Examples.

### Examples 1 to 7 and Comparative Examples 1 to 5

### Manufacturing of Solar Cell

Transparent electrode substrate 11 (manufactured by Nippon Sheet Glass Co., Ltd., glass with an SnO₂ film) having conductive layer 2 composed of SnO₂ formed on support 1 made of glass was prepared. This transparent electrode substrate 11 had a size of 30 mm×30 mm×1.0 mm (thickness). A part of conductive layer 2 in transparent electrode substrate 11 was cut with laser scribing to form scribe line portion 3 having line width D=20, 30, 40, 50, 60 μm (Comparative Examples 1 to 5) and 70, 80, 90, 100, 150, 200, 500 μm (Examples 1 to 7).

Then, a screen plate having a pattern of photoelectric conversion layer 4 and a screen printer (manufactured by Newlong Seimitsu Kogyo Co., Ltd., model number: LS-150) were used to apply a commercially available titanium oxide paste (manufactured by Solaronix, trade name: D/SP, an average particle size of 18 nm) onto conductive layer 2, and leveling for 1 hour at room temperature was carried out. Thereafter, an obtained coating film was dried for 20 minutes in an oven set at 80° C. and further fired for 60 minutes in air by using a firing furnace (manufactured by Denken Co., Ltd., model number: KDF P-100) set at 500° C. The step of applying the titanium oxide paste, the drying step, and the firing step were repeated three times, to thereby obtain a porous semiconductor layer having a film thickness of 15 μm.

Then, a paste containing zirconia particles (average particle size of 50 nm) was applied onto the porous semiconductor layer with the use of a screen printer, Thereafter, firing at 500° C. was carried out for 60 minutes, so that porous insulating layer 5 was formed. Here, a diameter of pores in porous insulating layer 5 was measured with the BET method (manufactured by Yuasa Ionics Co., Ltd., model No. AUTOSORB-1), and it was 100 μm.

Then, a mask having a prescribed pattern formed and a vapor deposition apparatus (manufactured by Anelva Corporation, model number: EVD500A) were used to form a film composed of titanium to a thickness of 400 nm on porous insulating layer 5 at a vapor deposition rate of 8 Å/s. Thus, counter electrode conductive layer 6 was obtained.

Then, a mask having a prescribed pattern formed and the vapor deposition apparatus (manufactured by Anelva Corporation, model number: EVD500A) were used to form a film composed of Pt on counter electrode conductive layer 6 at a vapor deposition rate of 4 Å/s. Thus, a catalyst layer was formed on counter electrode conductive layer 6, and a stack (the stack being formed by successively stacking the porous semiconductor layer, porous insulating layer 5, counter electrode conductive layer 6, and the catalyst layer) was formed on transparent electrode substrate 11. It is noted that a size and a position of the catalyst layer were the same as those of the porous semiconductor layer.

The stack was then immersed in a dye adsorption solution prepared in advance at room temperature for 100 hours. Thereafter, the stack was washed with ethanol and dried at approximately 60° C. for approximately 5 minutes, so that a sensitizing dye was adsorbed to the porous semiconductor layer.

Here, the adsorption dye solution was prepared by dissolving a dye shown in the chemical formula (1) above (manufactured by Solaronix, trade name: Ruthenium 620 1H3TBA) in a mixture solvent of acetonitrile and t-butanol at a volume ratio of 1:1 such that concentration attained to 4×10⁻⁴ mol/liter.

Then, transparent electrode substrate 11 having the stack formed and cover layer 7 made of glass were bonded to each other with the use of a heat seal film (manufactured by Du Pont Kabushiki Kaisha, Himilan 1855) cut in a shape surrounding the stack. Then, the substrate was heated for 10 minutes in an oven set to approximately 100° C. The heat seal film was thus molten to become insulating member 8, and the molten heat seal film, and transparent electrode substrate 11 and cover layer 7 were compression-bonded to each other.

Then, an electrolytic solution prepared in advance was introduced through an electrolytic solution introduction hole formed in advance in cover layer 7. When a space formed by transparent electrode substrate 11, cover layer 7, and insulating member 8 was filled with the electrolytic solution, the electrolytic solution introduction hole was sealed with an ultraviolet curable resin (manufactured by ThreeBond Co., Ltd., model number: 31X-101). A wet-type solar cell (single cell) was thus completed.

Here, the electrolytic solution was prepared in accordance with a method shown below. In acetonitrile as the solvent. LiI (manufactured by Aldrich, a redox species) and I₂ (manufactured by Kishida Chemical Co., Ltd., a redox species) were dissolved such that their concentrations were set to 0.1 mol/liter and 0.01 mol/liter, respectively. Furthermore, t-butyl pyridine (manufactured by Aldrich, an additive) and dimethyl propyl imidazole iodide (manufactured by Shikoku Chemicals Corporation) were dissolved in acetonitrile above such that their concentrations were set to 0.5 mol/liter and 0.6 mol/liter, respectively

An Ag paste (manufactured by Fujikura Kasei Co., Ltd., trade name: Dotite) was applied onto transparent electrode substrate 11 of the obtained wet-type solar cell to thereby form a collector electrode. The wet-type solar cells according to Examples 1 to 7 and Comparative Examples 1 to 5 were manufactured as above.

<Evaluation Method and Results>

A black mask having an area of an opening of 1.0 cm² was placed at the light receiving surface of the wet-type solar cell in each of Examples 1 to 7 and Comparative Examples 1 to 5. This wet-type solar cell was irradiated with light at intensity of 1 kW/m² (AM 1.5 solar simulator), and photoelectric conversion efficiency (η) was measured.

The wet-type solar cell according to each of Examples 1 to 7 and Comparative Examples 1 to 5 for which a black mask was placed was introduced in a constant temperature bath at 85° C., thermal stress was applied to the wet-type solar cell, and change over time in photoelectric conversion efficiency was measured. A sandwich cell (a sandwich cell being obtained by separately forming a negative electrode and a positive electrode and then bonding the same to each other) was prepared as a reference cell, and change in photoelectric conversion efficiency of the sandwich cell over time was also measured. Then, photoelectric conversion efficiency of the wet-type solar cell according to each of Examples 1 to 7 and Comparative Examples 1 to 5 was divided by photoelectric conversion efficiency of the sandwich cell, to thereby calculate a rate of retention of conversion efficiency with respect to the sandwich cell. A higher rate of retention of conversion efficiency with respect to the sandwich cell means better photoelectric conversion efficiency.

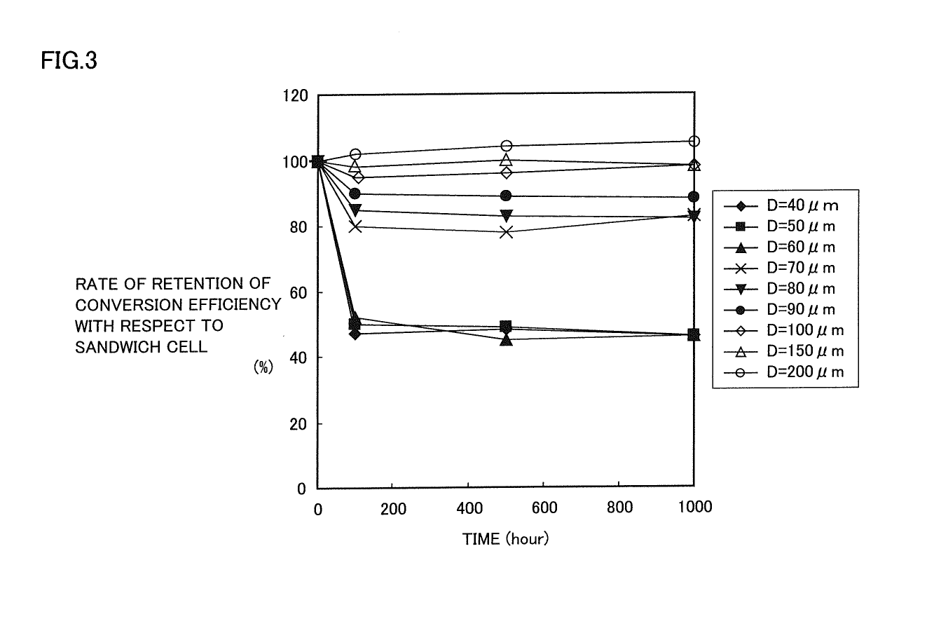

FIG. 3 shows change over time in rate of retention of photoelectric conversion efficiency with respect to the sandwich cell (the reference cell). As shown in FIG. 3, when line width D of scribe line portion 3 is equal to or greater than 70 μm, a rate of retention of conversion efficiency with respect to the sandwich cell starts to increase.

When line width D of scribe line portion 3 is equal to or greater than 100 μm, a rate of retention of conversion efficiency with respect to the sandwich cell is approximately 100%, and when line width D of scribe line portion 3 is equal to or greater than 200 μm, a rate of retention of conversion efficiency with respect to the sandwich cell exceeds 100%.

### Examples 8 to 9 and Comparative Examples 6 to 7

### Manufacturing of Wet-Type Solar Cell Module

The wet-type solar cell module shown in FIG. 2 was manufactured.

Initially, transparent electrode substrate 31 (manufactured by Nippon Sheet Glass Co., Ltd., trade name: glass with an SnO₂ film: 60 mm long×37 mm wide) having conductive layer (SnO₂ film) 2 formed on the surface of support 21 was prepared. A part of conductive layer 2 of transparent electrode substrate 31 was removed by laser scribing, to thereby form scribe line portions 3 extending in a longitudinal direction of transparent electrode substrate 31 and in parallel to one another. By forming scribe line portions 3, conductive layer 2 was divided into three regions.

Here, scribe line portion 3 had line width D of 200 μm, 500 μm, 700 μm, and 1000 μm in Examples 8 and 9 and Comparative Examples 6 and 7, respectively.

Then, a porous semiconductor layer was formed in accordance with Example 1. Specifically, one porous semiconductor layer having a film thickness of 25 μm and a size of 5 mm wide and 50 mm long was formed around a position distant by 6.9 mm from the left end of transparent electrode substrate 31. A second porous semiconductor layer was formed around a position distant by 6.9 mm from the center of the first porous semiconductor layer, and a third porous semiconductor layer was formed around a position distant by 6.9 mm from the center of the second porous semiconductor layer. The porous semiconductor layers were the same in size.

Porous insulating layer 5 was formed on each porous semiconductor layer in accordance with Example 1.

Then, counter electrode conductive layer 6 was formed on each porous insulating layer 5 in accordance with Example 1. One counter electrode conductive layer 6 having a size of 5.6 mm wide and 50 mm long was formed around a position distant by 7.2 mm from the left end of transparent electrode substrate 31. Second counter electrode conductive layer 6 was formed around a position distant by 7 mm from the center of first counter electrode conductive layer 6, and third counter electrode conductive layer 6 was formed around a position distant by 7 mm from the center of second counter electrode conductive layer 6. The counter electrode conductive layers 6 were the same in size.

Then, a catalyst layer composed of Pt was formed on each counter electrode conductive layer 6 in accordance with Example 1. It is noted that a size and a position of the catalyst layer were the same as those of the porous semiconductor layer.

The stack thus obtained was immersed in a dye adsorption solution employed in Example 1 at room temperature for 120 hours so that a sensitizing dye adsorbed to the porous semiconductor layer to thereby form photoelectric conversion layer 4.

Then, an ultraviolet curable resin (manufactured by ThreeBond Co., Ltd., 31X-101) was applied in between adjacent stacks and around the cell with the use of a dispenser (manufactured by EFD, ULTRASAVER). A glass substrate of 60 mm long×30 mm wide was bonded as cover layer 27 to the ultraviolet curable resin, and thereafter the ultraviolet curable resin was irradiated with ultraviolet rays from an ultraviolet lamp (manufactured by EFD, NOVACURE). Thus, the ultraviolet curable resin was cured to form insulating member 8 and sealing member 32.

Thereafter, an electrolytic solution the same as in Example 1 was introduced through the electrolytic solution introduction hole provided in advance in cover layer 27. When a space formed by transparent electrode substrate 31, cover layer 27, and insulating member 8 or sealing member 32 was filled with the electrolytic solution, the electrolytic solution introduction hole was sealed with the ultraviolet curable resin (manufactured by ThreeBond Co., Ltd., model No.: 31 X-101).

An Ag paste (manufactured by Fujikura Kasei Co., Ltd., trade name: Dotite) was applied onto the surface of support 21 to thereby form collector electrode 33. The wet-type solar cell module was thus completed.

<Evaluation Method and Results>

A black mask was placed at a light receiving surface of the wet-type solar cell module in each of Examples 8 to 9 and Comparative Examples 6 to 7. Then, this wet-type solar cell module was irradiated with light at intensity of 1 kW/m² (AM 1.5 solar simulator), and photoelectric conversion efficiency was measured.

In Examples 8 and 9, photoelectric conversion efficiency of the wet-type solar cell modules was substantially the same. Even in a case that thermal stress was applied to the wet-type solar cell module in accordance with Example 1 and change over time in photoelectric conversion efficiency was measured, a rate of retention of conversion efficiency of the wet-type solar cell module was the same as in Example 7.

In Comparative Examples 6 and 7, line width D of scribe line portion 3 was excessively large, which resulted in increase in non-light-receiving area and lowering in photoelectric conversion efficiency as compared with Example 8.

It should be understood that the embodiment and the examples disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1, 21 support; 2 conductive layer; 3 scribe line portion; 4 photoelectric conversion layer; 5 porous insulating layer; 6 counter electrode conductive layer 7, 27 cover layer; 8 insulating member; 10 wet-type solar cell; 11, 31 transparent electrode substrate; 20 wet-type solar cell module; 32 sealing member; and 33 collector electrode.

1. A wet-type solar cell, comprising:
a support composed of a light transmissive material; and
a photoelectric conversion element having a conductive layer, a photoelectric conversion layer including a porous semiconductor layer, a porous insulating layer, and a counter electrode conductive layer successively provided on said support,
a first region where said photoelectric conversion layer is provided on said conductive layer and a second region where said photoelectric conversion layer is not provided on said conductive layer being present, with a scribe line portion formed by not providing said conductive layer on said support lying therebetween,
said counter electrode conductive layer extending from said first region to said second region over said scribe line portion, and
said scribe line portion having a line width not smaller than 70 μm.

2. The wet-type solar cell according to claim 1, wherein
said scribe line portion has a line width not greater than 500 μm.

3. The wet-type solar cell according to claim 1, wherein
at least a part of said scribe line portion is in contact with an electrolytic solution present in a cavity in said porous insulating layer.

4. The wet-type solar cell according to claim 1, wherein
said porous insulating layer is provided on said scribe line portion.

5. The wet-type solar cell according to claim 1, wherein
said porous insulating layer has a pore diameter not smaller than 50 μm.

6. The wet-type solar cell according to claim 1, wherein
said porous insulating layer contains at least one of zirconium oxide and titanium oxide having an average particle size not smaller than 100 nm.

7. The wet-type solar cell according to claim 1, wherein
said porous semiconductor layer contains titanium oxide having an average particle size not greater than 100 nm.

8. A wet-type solar cell module in which two or more wet-type solar cells are connected in series,
at least one said wet-type solar cell including the photoelectric conversion element included in the wet-type solar cell according to claim 1,
the photoelectric conversion element included in said wet-type solar cell being provided on one support,
a conductive layer of one wet-type solar cell of adjacent wet-type solar cells being electrically connected to a counter electrode conductive layer of the other wet-type solar cell, and
between said one wet-type solar cell and said other wet-type solar cell, an insulating member preventing an electrolytic solution contained in one wet-type solar cell from moving to the other wet-type solar cell being provided.

9. The wet-type solar cell module according to claim 8, wherein
said insulating member is not in direct contact with said scribe line portion.
